(19) United States
(12) Patent Application Publication
(10) Pub. No.: US 2026/0318383 A1
(43) Pub. Date: Oct. 15, 2026

(54) SELF LEVELIZER SHOCK ABSORBER

(71) Applicant: HL MANDO CORPORATION, Gyeonggi-do (KR)

(72) Inventor: Taksun SONG, Gyeonggi-do (KR)

(21) Appl. No.: 19/633,878

(22) Filed: Mar. 30, 2026

(30) Foreign Application Priority Data
Apr. 10, 2025 (KR) 10-2025-0046644

(51) Int. Cl. F16F 9/512; F16F 9/32

(52) U.S. Cl. CPC F16F 9/5126; F16F 9/3214

(57) ABSTRACT

A self levelizer shock absorber according to an embodiment of the present invention includes a first cylinder therein, a piston rod reciprocating inside the first cylinder and having a hollow portion formed therein, a piston valve mounted on one end of the piston rod to partition an inside of the first cylinder into a compression chamber and a rebound chamber, a pump tube formed in the hollow portion of the piston rod, a pump rod having one end inserted into the pump tube and the other end positioned at an end portion of the first cylinder on a side of the compression chamber and having a hollow passage formed therein, a second cylinder surrounding the first cylinder leaving a space in which a low pressure chamber, a gas chamber, and a high pressure chamber are formed between the second cylinder and the first cylinder, and a body valve assembly installed at the end portion of the first cylinder on the side of the compression chamber and including a first body passage connecting the hollow passage of the pump rod and the low pressure chamber, a second body passage connecting the compression chamber and the high pressure chamber, and a body orifice formed on a movement path of a working fluid between the compression chamber and the high pressure chamber.

### TECHNICAL FIELD

The present invention relates to a self levelizer shock absorber.

### BACKGROUND ART

In general, a shock absorbing device is installed between an axle and a vehicle body to improve ride comfort by cushioning shocks or vibrations that the axle receives from a road surface during driving, and a shock absorber is used as one of such shock absorbing devices.

The shock absorber is also called a damper, and operates according to vibrations of the vehicle caused by road surface conditions. At this time, a damping force generated by the shock absorber varies depending on an operating speed of the shock absorber, that is, whether the operating speed is fast or slow.

Meanwhile, in a vehicle transporting a relatively large number of passengers or cargo, a vehicle height varies depending on the amount of passengers and cargo, and such a change in the height of the vehicle reduces ride comfort and steering stability. Accordingly, a self levelizer shock absorber having a function of maintaining the vehicle height at a constant level regardless of changes in a load of the vehicle has been developed.

However, since such a self levelizer shock absorber requires an additional pump tube, pump rod, and the like to implement a pumping operation in addition to a cylinder, a piston valve, and a body valve used in a general shock absorber, there is a problem in that it is difficult to implement a high damping force due to a large number of components installed inside the cylinder.

### SUMMARY OF THE INVENTION

### Technical Problem

An embodiment of the present invention provides a self levelizer shock absorber with improved damping force.

### Solution to the Problem

According to an embodiment of the present invention, a self levelizer shock absorber includes a first cylinder filled with a working fluid therein, a piston rod reciprocating inside the first cylinder and having a hollow portion formed therein, a piston valve mounted on one end of the piston rod to partition the inside of the first cylinder into a compression chamber and a rebound chamber and having a piston orifice formed therein to form a movement path of the working fluid between the compression chamber and the rebound chamber, a pump tube formed in the hollow portion of the piston rod, a pump rod having one end inserted into the pump tube and the other end positioned at an end portion of the first cylinder on a side of the compression chamber and having a hollow passage formed therein, and a space formed between the first cylinder and a low pressure chamber, a gas chamber, and a high pressure chamber, leaving the space, a second cylinder surrounding the first cylinder, and a body valve assembly installed at the end portion of the first cylinder on the side of the compression chamber and including a first body passage connecting the hollow passage of the pump rod and the low pressure chamber, a second body passage connecting the compression chamber and the high pressure chamber, and a body orifice formed on a movement path of the working fluid between the compression chamber and the high pressure chamber.

The self levelizer shock absorber may further include a diaphragm configured to separate the gas chamber and the high pressure chamber in a space between the first cylinder and the second cylinder. And the high pressure chamber may be configured to be pressurized by the gas chamber.

The self levelizer shock absorber may further include a relief valve configured to maintain a pressure of the high pressure chamber by moving the working fluid in the high pressure chamber to the low pressure chamber when the pressure of the high pressure chamber rises above a preset pressure.

The self levelizer shock absorber may further include an inlet valve formed at the one end of the pump rod, and an outlet valve formed at the other end opposite to one end of the pump tube facing the one end of the pump rod. And a space inside the pump tube between the inlet valve and the outlet valve may form a pump chamber.

The self levelizer shock absorber may further include a spring installed in the hollow portion of the piston rod facing the outlet valve. And the outlet valve may be configured to be opened while compressing the spring, and to move to the original position by an elastic force of the spring.

The self levelizer shock absorber may further include a base cap configured to block one end of the second cylinder facing the end portion of the first cylinder on the side of the compression chamber, and an eye installed on the base cap and coupled to the axle of the vehicle.

The other end of the second cylinder may be sealed by an upper cap.

The self levelizer shock absorber may further include a rod guide installed at an end portion of the first cylinder on a side of the rebound chamber to guide the piston rod, and an oil seal configured to block the end portion of the first cylinder on the side of the rebound chamber.

In addition, according to another embodiment of the present invention, a self levelizer shock absorber includes a first cylinder filled with a working fluid therein, a piston rod reciprocating inside the first cylinder and having a hollow portion formed therein, a piston valve mounted on one end of the piston rod to partition the inside of the first cylinder into a compression chamber and a rebound chamber and having a piston orifice formed therein to form a movement path of the working fluid between the compression chamber and the rebound chamber, a pump tube formed in the hollow portion of the piston rod, a pump rod having one end inserted into the pump tube and the other end positioned at an end portion of the first cylinder on a side of the compression chamber and having a hollow passage formed therein, and leaving a space formed between the first cylinder and a low pressure chamber, a gas chamber, and a high pressure chamber, a second cylinder surrounding the first cylinder, a body valve installed at the end portion of the first cylinder on the side of the compression chamber and having a first body passage connecting the hollow passage of the pump rod and the low pressure chamber and a second body passage connecting the compression chamber and the high pressure chamber, and an additional damping valve installed in a space between the end portion of the first cylinder on the side of the compression chamber and the second cylinder and having an additional orifice formed on a movement path of the working fluid between the compression chamber and the high pressure chamber.

The self levelizer shock absorber may further include an additional damping valve support bracket installed in the space between the end portion of the first cylinder on the side of the compression chamber and the second cylinder to surround and support the additional damping valve.

The additional damping valve support bracket may include a “U” shape opened toward the end portion of the first cylinder on the side of the compression chamber.

In addition, the additional damping valve support bracket may include an “M” shape opened in a direction opposite to a direction of the end portion of the first cylinder on the side of the compression chamber.

And the end portion of the first cylinder on the side of the compression chamber may be formed in a convexly curved shape toward the second cylinder.

The self levelizer shock absorber may further include a diaphragm configured to separate the gas chamber and the high pressure chamber in a space between the first cylinder and the second cylinder. And the high pressure chamber may be configured to be pressurized by the gas chamber.

The self levelizer shock absorber may further include a relief valve configured to maintain a pressure of the high pressure chamber by moving the working fluid in the high pressure chamber to the low pressure chamber when the pressure of the high pressure chamber rises above a preset pressure.

The self levelizer shock absorber may further include an inlet valve formed at the one end of the pump rod, and an outlet valve formed at the other end opposite to one end of the pump tube facing the one end of the pump rod. And a space inside the pump tube between the inlet valve and the outlet valve may form a pump chamber.

The self levelizer shock absorber may further include a spring installed in the hollow portion of the piston rod facing the outlet valve.

The outlet valve may be configured to be opened while compressing the spring, and to move to the original position by an elastic force of the spring.

The self levelizer shock absorber may further include a base cap configured to block one end of the second cylinder facing the end portion of the first cylinder on the side of the compression chamber, and an eye installed on the base cap and coupled to the axle of the vehicle.

The other end of the second cylinder may be sealed by an upper cap.

The self levelizer shock absorber may further include a rod guide installed at an end portion of the first cylinder on a side of the rebound chamber to guide the piston rod, and an oil seal configured to block the end portion of the first cylinder on the side of the rebound chamber.

### Advantageous Effects of the Invention

According to the embodiment of the present invention, the self levelizer shock absorber may effectively improve a damping force.

### BRIEF DESCRIPTION OF DRAWINGS

FIG. 1 is a cross-sectional view of a self levelizer shock absorber according to a first embodiment of the present invention.

FIGS. 2 to 5 are views for explaining an operating principle of the self levelizer shock absorber according to the first embodiment of the present invention.

FIG. 6 is a cross-sectional view of a self levelizer shock absorber according to a second embodiment of the present invention.

FIGS. 7 to 10 are views for explaining an operating principle of the self levelizer shock absorber according to the second embodiment of the present invention.

FIG. 11 is a cross-sectional view of a self levelizer shock absorber according to a third embodiment of the present invention.

FIGS. 12 to 15 are views for explaining an operating principle of the self levelizer shock absorber according to the third embodiment of the present invention.

### DETAILED DESCRIPTION OF THE INVENTION

Hereinafter, embodiments of the present invention will be described in detail with reference to the accompanying drawings so that those skilled in the art to which the present invention pertains can easily carry out the present invention. The present invention may be implemented in various different forms and is not limited to the embodiments described herein.

In addition, in various embodiments, components having the same configuration will be representatively described in the first embodiment using the same reference numerals, and in other embodiments, only configurations different from those of the first embodiment will be described.

It is noted that the drawings are schematic and are not drawn to scale. The relative dimensions and proportions of parts in the drawings may be exaggerated or reduced for clarity and convenience, and any dimensions illustrated are merely exemplary and not intended to be limiting. In addition, when identical structures, elements, or parts appear in more than one drawing, the same reference numerals are used to indicate similar features.

The embodiments of the present invention specifically illustrate ideal embodiments of the present invention. As a result, various modifications of the illustrations are expected. Therefore, the embodiments are not limited to the specific shapes of the areas shown, but also include, for example, variations in shape resulting from manufacturing.

Additionally, all technical and scientific terms used in this specification, unless otherwise defined, have the meaning commonly understood by a person of ordinary skill in the art to which the present invention pertains. All terms used in this specification have been selected for the purpose of more clearly describing the present invention and have not been selected to limit the scope of rights according to the present invention.

Additionally, expressions such as “including,” “comprising,” and “having” used in this specification should be understood as open-ended terms that imply the possibility of including other embodiments, unless otherwise stated in the phrase or sentence in which the expression is included.

Additionally, the singular expressions used herein may include plural meanings unless otherwise specified, and the same shall apply to the singular expressions used in the claims.

In addition, expressions such as ‘first’, ‘second’, etc. used in this specification are used to mutually distinguish multiple components, and do not limit the order or importance of the components.

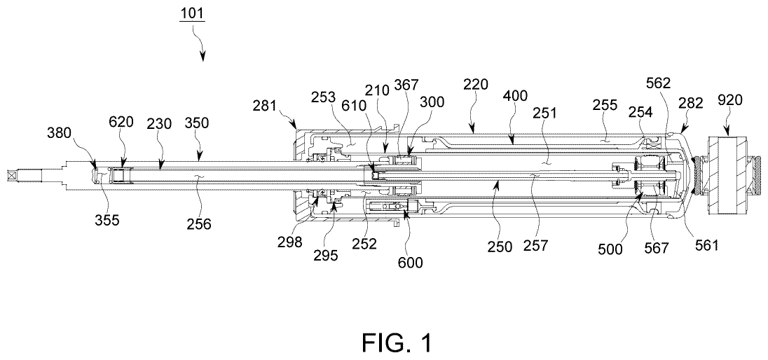

Hereinafter, a self levelizer shock absorber 101 according to a first embodiment of the present invention will be described with reference to FIG. 1. Here, the shock absorber is also called a damper, and may be installed in a vehicle, for example, to absorb and cushion a shock or vibration that an axle receives from a road surface during driving. In addition, the self levelizer shock absorber 101 may constantly maintain a vehicle height regardless of a change in a load of the vehicle.

As illustrated in FIG. 1, the self levelizer shock absorber 101 includes a first cylinder 210, a second cylinder 220, a piston rod 350, a piston valve 300, a pump tube 230, a pump rod 250, and a body valve assembly 500.

In addition, the self levelizer shock absorber 101 may further include a diaphragm 400, a relief valve 600, an inlet valve 610, an outlet valve 620, a spring 380, a base cap 282, an eye 920, an upper cap 281, a rod guide 295, and an oil seal 298.

The first cylinder 210 is filled with a working fluid therein. As an example, the working fluid may be a gas or an oil.

Specifically, the first cylinder 210 may include a hollow cylindrical shape forming a space therein. And the piston valve 300 to be described later is provided to be capable of moving up and down inside the first cylinder 210, and an inside of the first cylinder 210 may be partitioned into a compression chamber 251 and a rebound chamber 252 by the piston valve 300. For example, an upper portion of the first cylinder 210 with respect to the piston valve 300 may become the rebound chamber 252, and a lower portion of the first cylinder 210 may become the compression chamber 251.

The second cylinder 220 surrounds the first cylinder 210 leaving a space, and forms a low pressure chamber 253, a gas chamber 255, and a high pressure chamber 254 between the second cylinder 220 and the first cylinder 210.

The piston rod 350 may reciprocate inside the first cylinder 210. And a hollow portion 355 is formed inside the piston rod 350. And the piston valve 300 is mounted on one end of the piston rod 350.

The piston valve 300 is mounted on the one end of the piston rod 350 to partition the inside of the first cylinder 210 into the compression chamber 251 and the rebound chamber 252. And a piston orifice 367 is formed in the piston valve 300 to form a movement path of the working fluid between the compression chamber 251 and the rebound chamber 252.

The pump tube 230 is formed in the hollow portion 355 of the piston rod 350.

The pump rod 250 has one end inserted into the pump tube 230 and the other end positioned at an end portion of the first cylinder 210 on a side of the compression chamber 251. And a hollow passage 257 is formed inside the pump rod 250.

The inlet valve 610 may be formed at the one end of the pump rod 250, and the outlet valve 620 may be formed at the other end opposite to one end of the pump tube 230 facing the one end of the pump rod 250. That is, the outlet valve 620 may be formed on a side of the other end of the piston rod 350 that is not inserted into the first cylinder 210.

And a space inside the pump tube 230 between the inlet valve 610 and the outlet valve 620 may form a pump chamber 256.

The spring 380 may be installed in the hollow portion 355 of the piston rod 350 facing the outlet valve 620. Accordingly, the outlet valve 620 may be configured to be opened while compressing the spring 380, and to move to the original position by an elastic force of the spring 380.

The rod guide 295 is installed at an end portion of the first cylinder 210 on a side of the rebound chamber 252 into which the piston rod 350 is inserted to guide the piston rod 350.

The oil seal 298 blocks the end portion of the first cylinder 210 on the side of the rebound chamber 252 to prevent leakage of the working fluid filled inside the first cylinder 210.

The body valve assembly 500 is installed at the end portion of the first cylinder 210 on the side of the compression chamber 251. And the body valve assembly 500 includes a first body passage 561 connecting the hollow passage 257 of the pump rod 250 and the low pressure chamber 253, and a second body passage 562 connecting the compression chamber 251 and the high pressure chamber 254. In addition, the body valve assembly 500 further includes a body orifice 567 formed on a movement path of the working fluid between the compression chamber 251 and the high pressure chamber 254. Here, the body orifice 567 formed in the body valve assembly 500 generates a damping force in a compression stroke and a rebound stroke together with the piston orifice 367 formed in the piston valve 300.

That is, the self levelizer shock absorber 101 according to the first embodiment of the present invention may generate the damping force in the body valve assembly 500 together with the piston valve 300. In particular, by forming the body orifice 567 for generating the damping force in the body valve assembly 500, the damping force may be effectively improved even in a narrow installation space inside the first cylinder 210 and the second cylinder 220.

Meanwhile, the body valve assembly 500 may be assembled such that a body valve and an additional damping valve form a single assembly.

The diaphragm 400 may separate the gas chamber 255 and the high pressure chamber 254 in a space between the first cylinder 210 and the second cylinder 220. And the high pressure chamber 254 may be pressurized by the gas chamber 255.

The relief valve 600 maintains a pressure of the high pressure chamber 254 by moving the working fluid in the high pressure chamber 254 to the low pressure chamber 253 when the pressure of the high pressure chamber 254 rises above a preset pressure.

The base cap 282 may block one end of the second cylinder 220 facing the end portion of the first cylinder 210 on the side of the compression chamber 251. That is, the base cap 282 faces the end portion of the first cylinder 210 on the side of the compression chamber 251 while blocking the one end of the second cylinder 220.

The eye 920 may be installed on the base cap 282 and coupled to an axle of the vehicle.

Meanwhile, although not illustrated, an eye may also be installed at the other end of the piston rod 350. At this time, the eye installed at the other end of the piston rod 350 may be referred to as an upper eye, and the eye installed on the base cap 282 may be referred to as a lower eye. That is, the self levelizer shock absorber 101 may be mounted to the vehicle body and the axle through the upper eye and the lower eye.

The upper cap 281 may seal the other end of the second cylinder 220.

With such a configuration, the self levelizer shock absorber 101 according to the first embodiment of the present invention may effectively improve the damping force.

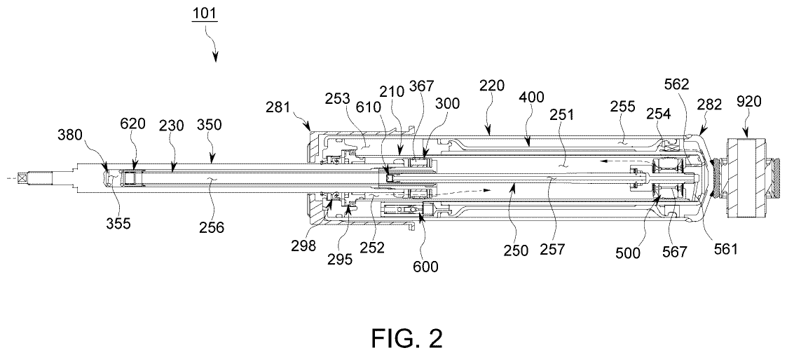

Hereinafter, an operating principle of the self levelizer shock absorber 101 according to the first embodiment of the present invention will be described in detail with reference to FIGS. 2 to 5.

An initial state in which the piston rod 350 is raised due to the opening of the inlet valve 610 and the outlet valve 620 is maintained, and when a load is generated in the vehicle due to passengers or cargo, the initially raised piston rod 350 descends.

In this state, as the piston rod 350 reciprocates in the first cylinder 210 during driving of the vehicle, a pressure difference is formed between the rebound chamber 252 and the compression chamber 251, so that the working fluid moves through the piston valve 300 and the body valve assembly 500, and pumping starts through the pump tube 230 and the pump rod 250.

Specifically, as illustrated in FIG. 2, the working fluid of the rebound chamber 252 flows to the compression chamber 251 through the piston orifice 367 of the piston valve 300 to generate a damping force. At this time, the working fluid of the high pressure chamber 254 flows to the compression chamber 251 through the body orifice 567 of the body valve assembly 500 to additionally generate a damping force.

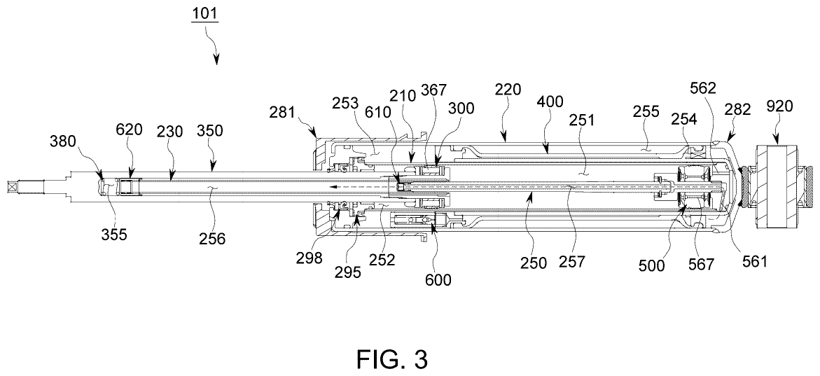

Meanwhile, as illustrated in FIG. 3, during a rebound stroke, the working fluid of the low pressure chamber 253 is suctioned toward a side of the pump chamber 256 while opening the inlet valve 610 through the first body passage 561, thereby raising the piston rod 350.

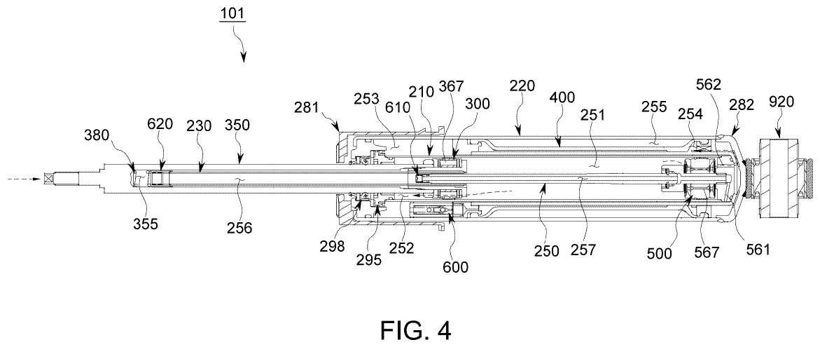

On the other hand, as illustrated in FIG. 4, during a compression stroke, the working fluid of the compression chamber 251 flows to the high pressure chamber 254 through the second body passage 562 connecting the compression chamber 251 and the high pressure chamber 254, and the working fluid of the compression chamber 251 flows to the rebound chamber 252 through the piston orifice 367 of the piston valve 300 to generate a damping force. At this time, the working fluid of the compression chamber 251 flows to the high pressure chamber 254 through the body orifice 567 of the body valve assembly 500 to additionally generate a damping force.

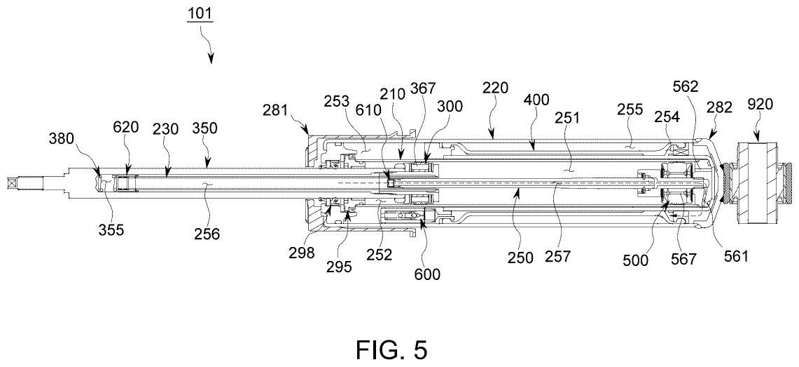

Meanwhile, as illustrated in FIG. 5, during the compression stroke, the working fluid of the pump chamber 256 is pumped to the high pressure chamber 254. And as pumping continues, a pressure of the high pressure chamber 254 increases due to compression of the fluid, thereby raising a position of the piston valve 300 to adjust the vehicle height.

According to such an operation, the vehicle height is adjusted, and when the pressure of the high pressure chamber 254 excessively increases, the working fluid of the high pressure chamber 254 moves to the low pressure chamber 253 through the relief valve 600 to lower the excessively increased pressure of the high pressure chamber 254 to maintain a constant state.

And a damping force is generated as the working fluid moves through the piston orifice 367 of the piston valve 300 and the body orifice 567 of the body valve assembly 500.

As described above, according to the first embodiment of the present invention, the self levelizer shock absorber 101 may effectively improve the damping force despite a limited installation space.

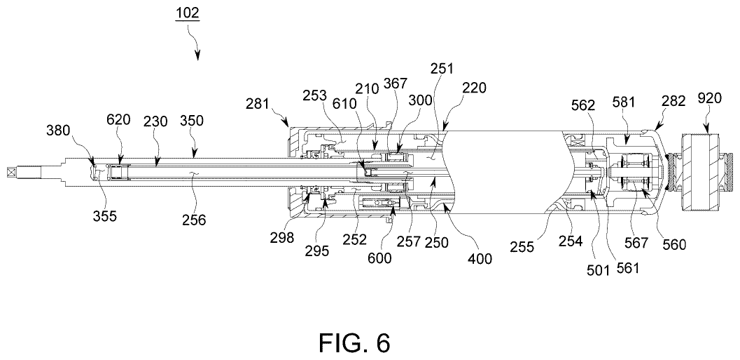

Hereinafter, a second embodiment of the present invention will be described with reference to FIG. 6.

As illustrated in FIG. 6, in a self levelizer shock absorber 102 according to the second embodiment of the present invention, a body valve 501 is installed at an end portion of the first cylinder 210 on a side of the compression chamber 251, and a first body passage 561 connecting the hollow passage 257 of the pump rod 250 and the low pressure chamber 253, and a second body passage 562 connecting the compression chamber 251 and the high pressure chamber 254 are formed in the body valve 501.

And the self levelizer shock absorber 102 according to the second embodiment of the present invention further includes a separate additional damping valve 560. That is, in the second embodiment of the present invention, the body valve 501 and the additional damping valve 560 are separately installed.

The additional damping valve 560 is installed in a space between the end portion of the first cylinder 210 on the side of the compression chamber 251 and the second cylinder 220 or the base cap 282, and an additional orifice 567 formed on a movement path of the working fluid between the compression chamber 251 and the high pressure chamber 254 is formed in the additional damping valve 560.

Accordingly, the additional damping valve 560 generates a damping force during a compression stroke and a rebound stroke together with the piston valve 300.

In addition, the self levelizer shock absorber 102 according to the second embodiment of the present invention may further include an additional damping valve support bracket 581.

The additional damping valve support bracket 581 may be installed in a space between the end portion of the first cylinder 210 on the side of the compression chamber 251 and the second cylinder 220 or the base cap 282 blocking one end of the second cylinder 220 to surround and support the additional damping valve 560. Such an additional damping valve support bracket 581 protects the additional damping valve 560 from a high load.

In addition, in the second embodiment of the present invention, the additional damping valve support bracket 581 may include a “U” shape opened toward the end portion of the first cylinder 210 on the side of the compression chamber 251.

In addition, in the second embodiment of the present invention, the remaining configurations except for the body valve 501, the additional damping valve 560, and the additional damping valve support bracket 581 are the same as those of the first embodiment described above.

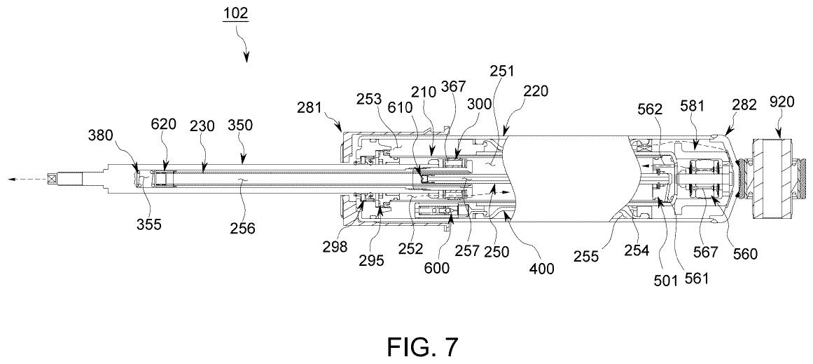

Hereinafter, an operating principle of the self levelizer shock absorber 102 according to the second embodiment of the present invention will be described in detail with reference to FIGS. 7 to 10.

An initial state in which the piston rod 350 is raised due to the opening of the inlet valve 610 and the outlet valve 620 is maintained, and when a load is generated in the vehicle due to passengers or cargo, the initially raised piston rod 350 descends.

In this state, as the piston rod 350 reciprocates in the first cylinder 210 during driving of the vehicle, a pressure difference is formed between the rebound chamber 252 and the compression chamber 251, so that the working fluid moves through the piston valve 300 and the body valve assembly 500, and pumping starts through the pump tube 230 and the pump rod 250.

Specifically, as illustrated in FIG. 7, the working fluid of the rebound chamber 252 flows to the compression chamber 251 through the piston orifice 367 of the piston valve 300 to generate a damping force. At this time, the working fluid of the high pressure chamber 254 flows to the compression chamber 251 through the body orifice 567 of the body valve assembly 500 to additionally generate a damping force.

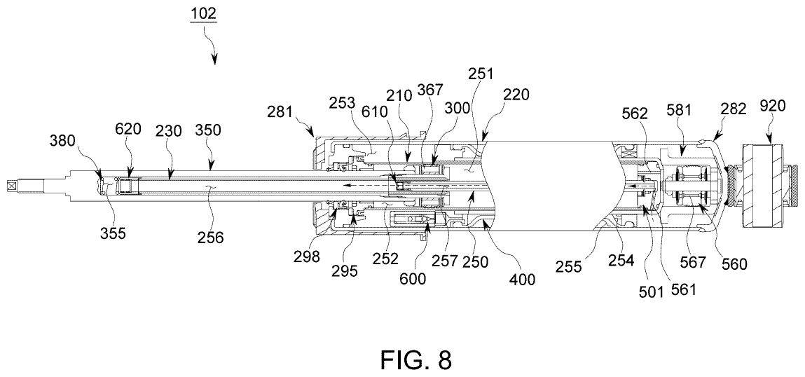

Meanwhile, as illustrated in FIG. 8, during a rebound stroke, the working fluid of the low pressure chamber 253 is suctioned toward a side of the pump chamber 256 while opening the inlet valve 610 through the first body passage 561, thereby raising the piston rod 350.

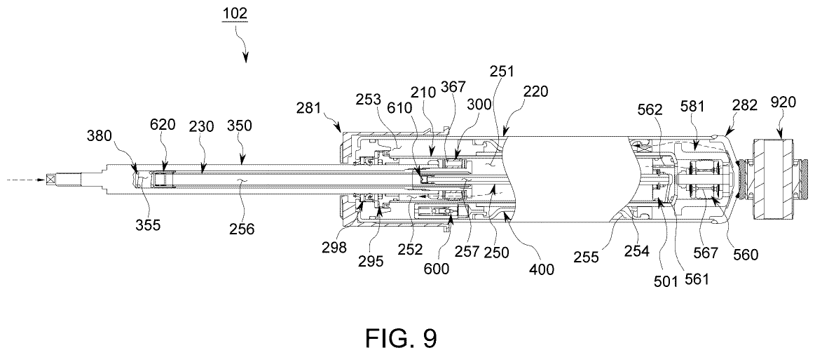

On the other hand, as illustrated in FIG. 9, during a compression stroke, the working fluid of the compression chamber 251 flows to the high pressure chamber 254 through the second body passage 562 connecting the compression chamber 251 and the high pressure chamber 254, and the working fluid of the compression chamber 251 flows to the rebound chamber 252 through the piston orifice 367 of the piston valve 300 to generate a damping force. At this time, the working fluid of the compression chamber 251 flows to the high pressure chamber 254 through the body orifice 567 of the body valve assembly 500 to additionally generate a damping force.

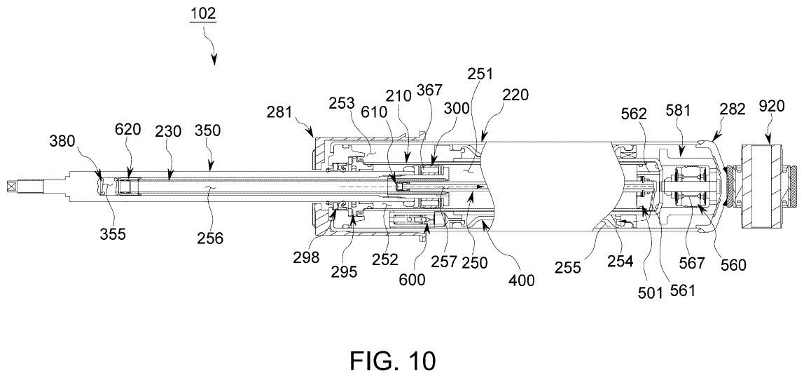

Meanwhile, as illustrated in FIG. 10, during the compression stroke, the working fluid of the pump chamber 256 is pumped to the high pressure chamber 254. And as pumping continues, a pressure of the high pressure chamber 254 increases due to compression of the fluid, thereby raising a position of the piston valve 300 to adjust the vehicle height.

According to such an operation, the vehicle height is adjusted, and when the pressure of the high pressure chamber 254 excessively increases, the working fluid of the high pressure chamber 254 moves to the low pressure chamber 253 through the relief valve 600 to lower the excessively increased pressure of the high pressure chamber 254 to maintain a constant state.

And a damping force is generated as the working fluid moves through the piston orifice 367 of the piston valve 300 and the body orifice 567 of the body valve assembly 500.

With such a configuration, the self levelizer shock absorber 102 according to the second embodiment of the present invention may also effectively improve the damping force.

Specifically, the vehicle height of the self levelizer shock absorber 102 is adjusted, and when the pressure of the high pressure chamber 254 excessively increases, the working fluid of the high pressure chamber 254 moves to the low pressure chamber 253 through the relief valve 600 to lower the excessively increased pressure of the high pressure chamber 254 to maintain a constant state.

And a damping force is generated as the working fluid moves through the piston orifice 367 of the piston valve 300 and the body orifice 567 of the body valve assembly 500.

As described above, according to the second embodiment of the present invention, the self levelizer shock absorber 102 may effectively improve the damping force despite a limited installation space.

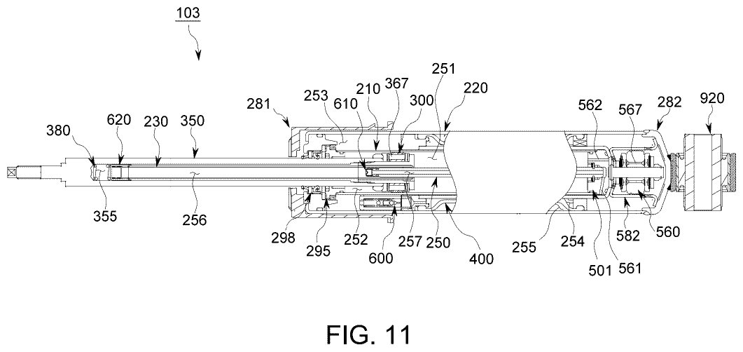

Hereinafter, a third embodiment of the present invention will be described with reference to FIG. 11.

As illustrated in FIG. 11, in a self levelizer shock absorber 103 according to the third embodiment of the present invention, a body valve 501 is installed at an end portion of the first cylinder 210 on a side of the compression chamber 251, and a first body passage 561 connecting the hollow passage 257 of the pump rod 250 and the low pressure chamber 253, and a second body passage 562 connecting the compression chamber 251 and the high pressure chamber 254 are formed in the body valve 501.

And the self levelizer shock absorber 103 according to the third embodiment of the present invention further includes a separate additional damping valve 560. That is, in the third embodiment of the present invention, the body valve 501 and the additional damping valve 560 are separately installed.

The additional damping valve 560 is installed in a space between the end portion of the first cylinder 210 on the side of the compression chamber 251 and the second cylinder 220 or the base cap 282, and an additional orifice 567 formed on a movement path of the working fluid between the compression chamber 251 and the high pressure chamber 254 is formed in the additional damping valve 560.

Accordingly, the additional damping valve 560 generates a damping force during a compression stroke and a rebound stroke together with the piston valve 300.

In addition, the self levelizer shock absorber 103 according to the third embodiment of the present invention may further include an additional damping valve support bracket 582.

The additional damping valve support bracket 581 may be installed in a space between the end portion of the first cylinder 210 on the side of the compression chamber 251 and the second cylinder 220 or the base cap 282 blocking one end of the second cylinder 220 to surround and support the additional damping valve 560. Such an additional damping valve support bracket 581 protects the additional damping valve 560 from a high load.

In addition, in the third embodiment of the present invention, the additional damping valve support bracket 582 may include an “M” shape opened in a direction opposite to a direction of the end portion of the first cylinder 210 on the side of the compression chamber 251.

And the end portion of the first cylinder 210 on the side of the compression chamber 251 may be formed in a convexly curved shape toward the second cylinder 220.

Accordingly, stable alignment between the end portion of the first cylinder 210 on the side of the compression chamber 251 and the additional damping valve support bracket 582 is possible, and the additional damping valve support bracket 582 may stably withstand a larger load.

For example, in a case of the second embodiment described above, when the first cylinder 210 strongly presses the additional damping valve support bracket 581, the additional damping valve support bracket 581 may not be able to withstand it, and there is a concern that an open end may spread.

However, according to the third embodiment of the present invention, even when the first cylinder 210 strongly presses the additional damping valve support bracket 582, the additional damping valve support bracket 582 may not spread and may stably maintain a shape.

That is, the additional damping valve support bracket 582 used in the third embodiment of the present invention may secure a same rigidity even with a smaller thickness than the additional damping valve support bracket 581 used in the previous second embodiment.

As described above, according to the third embodiment of the present invention, the additional damping valve support bracket 582 may stably withstand a higher load. Alternatively, since the additional damping valve support bracket 582 may secure the same rigidity even with a thin thickness, an internal space of the self levelizer shock absorber 103 may be utilized more efficiently.

In addition, in the third embodiment of the present invention, the remaining configurations except for the body valve 501, the additional damping valve 560, and the additional damping valve support bracket 582 are the same as those of the first embodiment described above.

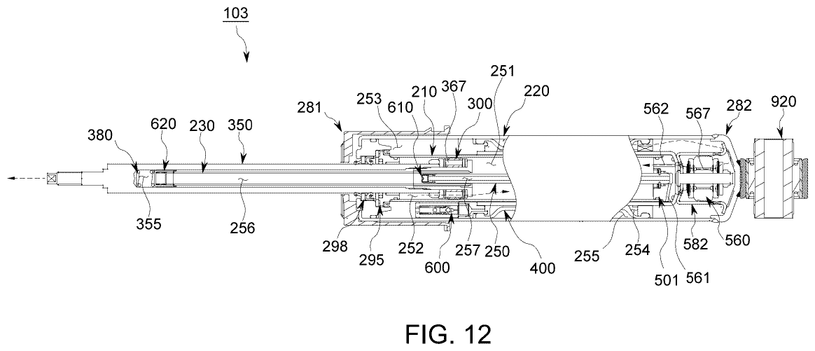

Hereinafter, an operating principle of the self levelizer shock absorber 103 according to the third embodiment of the present invention will be described in detail with reference to FIGS. 12 to 15.

An initial state in which the piston rod 350 is raised due to the opening of the inlet valve 610 and the outlet valve 620 is maintained, and when a load is generated in the vehicle due to passengers or cargo, the initially raised piston rod 350 descends.

In this state, as the piston rod 350 reciprocates in the first cylinder 210 during driving of the vehicle, a pressure difference is formed between the rebound chamber 252 and the compression chamber 251, so that the working fluid moves through the piston valve 300 and the body valve assembly 500, and pumping starts through the pump tube 230 and the pump rod 250.

Specifically, as illustrated in FIG. 12, the working fluid of the rebound chamber 252 flows to the compression chamber 251 through the piston orifice 367 of the piston valve 300 to generate a damping force. At this time, the working fluid of the high pressure chamber 254 flows to the compression chamber 251 through the body orifice 567 of the body valve assembly 500 to additionally generate a damping force.

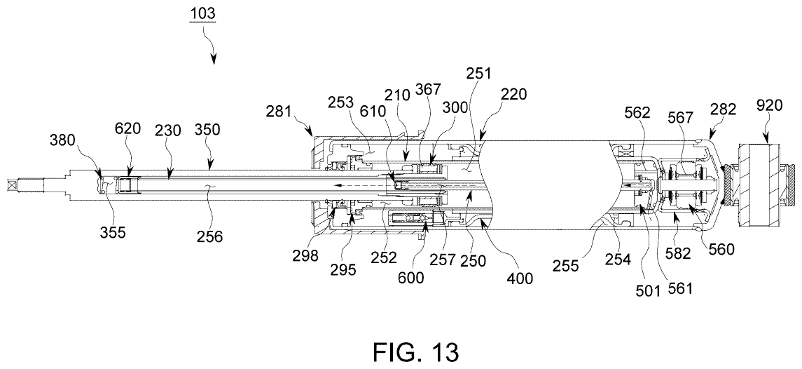

Meanwhile, as illustrated in FIG. 13, during a rebound stroke, the working fluid of the low pressure chamber 253 is suctioned toward a side of the pump chamber 256 while opening the inlet valve 610 through the first body passage 561, thereby raising the piston rod 350.

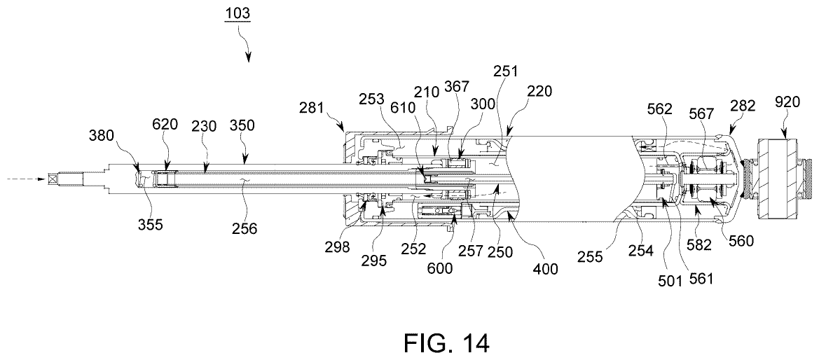

On the other hand, as illustrated in FIG. 14, during a compression stroke, the working fluid of the compression chamber 251 flows to the high pressure chamber 254 through the second body passage 562 connecting the compression chamber 251 and the high pressure chamber 254, and the working fluid of the compression chamber 251 flows to the rebound chamber 252 through the piston orifice 367 of the piston valve 300 to generate a damping force. At this time, the working fluid of the compression chamber 251 flows to the high pressure chamber 254 through the body orifice 567 of the body valve assembly 500 to additionally generate a damping force.

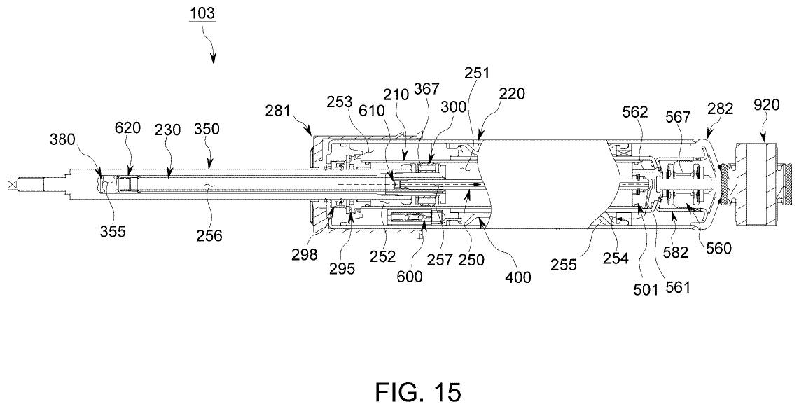

Meanwhile, as illustrated in FIG. 15, during the compression stroke, the working fluid of the pump chamber 256 is pumped to the high pressure chamber 254. And as pumping continues, a pressure of the high pressure chamber 254 increases due to compression of the fluid, thereby raising a position of the piston valve 300 to adjust the vehicle height.

According to such an operation, the vehicle height is adjusted, and when the pressure of the high pressure chamber 254 excessively increases, the working fluid of the high pressure chamber 254 moves to the low pressure chamber 253 through the relief valve 600 to lower the excessively increased pressure of the high pressure chamber 254 to maintain a constant state.

And a damping force is generated as the working fluid moves through the piston orifice 367 of the piston valve 300 and the body orifice 567 of the body valve assembly 500.

With such a configuration, the self levelizer shock absorber 103 according to the third embodiment of the present invention may also effectively improve the damping force.

Specifically, the vehicle height of the self levelizer shock absorber 103 is adjusted, and when the pressure of the high pressure chamber 254 excessively increases, the working fluid of the high pressure chamber 254 moves to the low pressure chamber 253 through the relief valve 600 to lower the excessively increased pressure of the high pressure chamber 254 to maintain a constant state.

And a damping force is generated as the working fluid moves through the piston orifice 367 of the piston valve 300 and the body orifice 567 of the body valve assembly 500.

As described above, according to the third embodiment of the present invention, the self levelizer shock absorber 103 may effectively improve the damping force despite a limited installation space.

In particular, according to the third embodiment of the present invention, the additional damping valve support bracket 582 may withstand a higher load and may stably support the additional damping valve 560.

Although the embodiments of the present invention have been described above with reference to the accompanying drawings, those skilled in the art to which the present invention pertains will understand that the present invention may be implemented in other specific forms without changing a technical spirit or an essential feature thereof.

Therefore, the embodiments described above should be understood as being exemplary and not limiting in all respects, and the scope of the present invention is indicated by the appended claims rather than the foregoing detailed description, and all changes or modifications derived from the meaning and scope of the claims and their equivalent concepts should be interpreted as being included in the scope of the present invention.

### REFERENCE NUMERALS

101, 102, 103: Self levelizer shock absorbers
210: First cylinder
220: Second cylinder
230: Pump tube
250: Pump rod
251: Compression chamber
252: Rebound chamber
253: Low pressure chamber
254: High pressure chamber
255: Gas chamber
256: Pump chamber
257: Hollow passage
281: Upper cap
282: Base cap
295: Rod guide
298: Oil seal
300: Piston valve
350: Piston rod
355: Hollow portion
367: Piston orifice
380: Spring
400: Diaphragm
500: Body valve assembly
501: Body valve
560: Additional damping valve
561: First body passage
562: Second body passage
567: Body orifice
581, 582: Additional damping valve support brackets
600: Relief valve
610: Inlet valve
620: Outlet valve
920: Eye

1. A self levelizer shock absorber comprising: a first cylinder filled with a working fluid therein;
a piston rod reciprocating inside the first cylinder and having a hollow portion formed therein;
a piston valve mounted on one end of the piston rod to partition an inside of the first cylinder into a compression chamber and a rebound chamber, and having a piston orifice formed therein to form a movement path of the working fluid between the compression chamber and the rebound chamber;
a pump tube formed in the hollow portion of the piston rod;
a pump rod having one end inserted into the pump tube and the other end positioned at an end portion of the first cylinder on a side of the compression chamber and having a hollow passage formed therein;
a second cylinder surrounding the first cylinder leaving a space in which a low pressure chamber, a gas chamber, and a high pressure chamber are formed between the second cylinder and the first cylinder; and
a body valve assembly installed at the end portion of the first cylinder on the side of the compression chamber and including a first body passage connecting the hollow passage of the pump rod and the low pressure chamber, a second body passage connecting the compression chamber and the high pressure chamber, and a body orifice formed on a movement path of the working fluid between the compression chamber and the high pressure chamber.

2. The self levelizer shock absorber of claim 1, further comprising
a diaphragm configured to separate the gas chamber and the high pressure chamber in a space between the first cylinder and the second cylinder, wherein
the high pressure chamber is configured to be pressurized by the gas chamber.

3. The self levelizer shock absorber of claim 2, further comprising
a relief valve configured to maintain a pressure of the high pressure chamber by moving the working fluid in the high pressure chamber to the low pressure chamber when the pressure of the high pressure chamber rises above a preset pressure.

4. The self levelizer shock absorber of claim 1, further comprising
an inlet valve formed at the one end of the pump rod; and
an outlet valve formed at the other end of the pump tube, opposite to the one end facing the one end of the pump rod,
wherein
a space inside the pump tube between the inlet valve and the outlet valve forms a pump chamber.

5. The self levelizer shock absorber of claim 4, further comprising
a spring installed in the hollow portion of the piston rod facing the outlet valve, wherein
the outlet valve is configured to be opened while compressing the spring, and to move to the original position by an elastic force of the spring.

6. The self levelizer shock absorber of claim 1, further comprising
a base cap configured to block one end of the second cylinder facing the end portion of the first cylinder on the side of the compression chamber; and
an eye installed on the base cap and coupled to an axle of a vehicle.

7. The self levelizer shock absorber of claim 6, wherein
the other end of the second cylinder is sealed by an upper cap.

8. The self levelizer shock absorber of claim 1, further comprising
a rod guide installed at an end portion of the first cylinder on a side of the rebound chamber to guide the piston rod; and
an oil seal configured to block the end portion of the first cylinder on the side of the rebound chamber.

9. A self levelizer shock absorber comprising: a first cylinder filled with a working fluid therein;
a piston rod reciprocating inside the first cylinder and having a hollow portion formed therein;
a piston valve mounted on one end of the piston rod to partition an inside of the first cylinder into a compression chamber and a rebound chamber, and having a piston orifice formed therein to form a movement path of the working fluid between the compression chamber and the rebound chamber;
a pump tube formed in the hollow portion of the piston rod;
a pump rod having one end inserted into the pump tube and the other end positioned at an end portion of the first cylinder on a side of the compression chamber and having a hollow passage formed therein;
a second cylinder surrounding the first cylinder leaving a space in which a low pressure chamber, a gas chamber, and a high pressure chamber are formed between the second cylinder and the first cylinder;
a body valve installed at the end portion of the first cylinder on the side of the compression chamber and having a first body passage connecting the hollow passage of the pump rod and the low pressure chamber and a second body passage connecting the compression chamber and the high pressure chamber; and
an additional damping valve installed in a space between the end portion of the first cylinder on the side of the compression chamber and the second cylinder and having an additional orifice formed on a movement path of the working fluid between the compression chamber and the high pressure chamber.

10. The self levelizer shock absorber of claim 9, further comprising
an additional damping valve support bracket installed in the space between the end portion of the first cylinder on the side of the compression chamber and the second cylinder to surround and support the additional damping valve.

11. The self levelizer shock absorber of claim 10, wherein
the additional damping valve support bracket includes a “U” shape opening toward the end portion of the first cylinder on the side of the compression chamber.

12. The self levelizer shock absorber of claim 10, wherein
the additional damping valve support bracket includes an “M” shape opening in a direction opposite to a direction of the end portion of the first cylinder on the side of the compression chamber.

13. The self levelizer shock absorber of claim 12, wherein
the end portion of the first cylinder on the side of the compression chamber is formed in a convexly curved shape toward the second cylinder.

14. The self levelizer shock absorber of claim 9, further comprising
a diaphragm configured to separate the gas chamber and the high pressure chamber in a space between the first cylinder and the second cylinder, wherein
the high pressure chamber is configured to be pressurized by the gas chamber.

15. The self levelizer shock absorber of claim 14, further comprising
a relief valve configured to maintain a pressure of the high pressure chamber by moving the working fluid in the high pressure chamber to the low pressure chamber when the pressure of the high pressure chamber rises above a preset pressure.

16. The self levelizer shock absorber of claim 9, further comprising
an inlet valve formed at the one end of the pump rod; and
an outlet valve formed at the other end of the pump tube, opposite to the one end facing the one end of the pump rod,
wherein
a space inside the pump tube between the inlet valve and the outlet valve forms a pump chamber.

17. The self levelizer shock absorber of claim 16, further comprising
a spring installed in the hollow portion of the piston rod facing the outlet valve, wherein
the outlet valve is configured to be opened while compressing the spring, and to move to the original position by an elastic force of the spring.

18. The self levelizer shock absorber of claim 9, further comprising
a base cap configured to block one end of the second cylinder facing the end portion of the first cylinder on the side of the compression chamber; and
an eye installed on the base cap and coupled to an axle of a vehicle.

19. The self levelizer shock absorber of claim 18, wherein
the other end of the second cylinder is sealed by an upper cap.

20. The self levelizer shock absorber of claim 9, further comprising
a rod guide installed at an end portion of the first cylinder on a side of the rebound chamber to guide the piston rod; and
an oil seal configured to block the end portion of the first cylinder on the side of the rebound chamber.
